(19) United States
(12) Patent Application Publication
(10) Pub. No.: US 2006/0002160 A1
(43) Pub. Date: Jan. 5, 2006

(54) Secondary side synchronous rectifier driver integrated circuits with adaptive turn-off for transformer coupled power supplies

(76) Inventor: Mehmet K. Nalbant, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/883,497

(22) Filed: Jul. 1, 2004

(51) Int. Cl. H02M 3/24

(52) U.S. Cl. 363/97

(57) ABSTRACT

Secondary side synchronous rectifier driver circuits with adaptive turn-off of each of a pair of synchronous rectifiers in the secondary circuit of isolated and non-isolated transformer coupled power supplies having a continuous inductor current. When a respective turnoff signal is received from the controller, each synchronous rectifier driver senses the synchronous rectifier switch current, and holds the respective synchronous rectifier switch on until the current in the switch goes to zero, indicating a proper charging or discharging of the transformer leakage inductance. This may be done, for example for a FET synchronous rectifier, by sensing the drain-source voltage and turning the FET off when the drain-source voltage goes to zero. This minimizes synchronous rectifier body diode or external Schottky diode conduction and energy loss. Other current sensing techniques may also be used, including but not limited to, current sense resistors and current sensing transformers. Specific embodiments are disclosed.

### BACKGROUND OF THE INVENTION

1. Field of the Invention

The present invention relates to the field of switching power supplies.

2. Prior Art

The continual trend in operating voltage reduction for modern VLSI ICs has created a need for power supplies with output voltages much lower than 5V. State of the art processors require supply voltages that are as low as 1.25V, with further reductions anticipated in the future to voltages below 1V. Traditionally, single phase or multiple phase buck regulators have been used to generate the required low voltages. The use of simple buck regulators, however, starts being problematic as duty cycles commanded by these low voltages are less than 10% with a power distribution bus of 12V, and the output currents are several tens of amps.

One way to alleviate this problem is to use voltage and current scaling through the use of a transformer. Although this solves the problems of current, voltage and duty cycle scaling, it introduces other problems that become pronounced, especially when output currents are several tens of amps, for example greater than 30 A. Such systems use synchronous rectification at the output (secondary side) for high efficiency. The synchronous rectifiers on the secondary side are commutated by signals obtained from a controller on the primary side.

This serves the purpose, to a certain degree, to lower power dissipation at the output rectifiers by using the synchronous rectification. However at high output currents, significant conduction of parasitic or external diodes across the synchronous rectifiers can take place that results in comparatively high losses. Such conduction of output diodes occurs as a result of uncoupled (to the primary) transformer and trace inductances. These inductances effectively appear as an inductance in series with the transformer secondary. The resulting diode conduction might be termed as forced diode conduction, due to stored parasitic energy in these unavoidable inductances.

Specifically, this loss occurs in the body diode of a synchronous rectifier, or external Schottky diode if used, when the corresponding synchronous FET is turned off from the primary side. The current that has been flowing in the FET gets diverted to the parallel diode and decays to zero amps.

### BRIEF SUMMARY OF THE INVENTION

Secondary side synchronous rectifier driver circuits with adaptive turn-off of each of a pair of synchronous rectifiers in the secondary circuit of isolated and non-isolated transformer coupled power supplies having a continuous inductor current are disclosed. When a respective turnoff signal is received from the controller, each synchronous rectifier driver senses the synchronous rectifier switch current, and holds the respective synchronous rectifier switch on until the current in the switch goes to zero, indicating a proper charging or discharging of the transformer leakage inductance. This may be done, for example for a FET synchronous rectifier, by sensing the drain-source voltage and turning the FET off when the drain-source voltage goes to zero. This minimizes synchronous rectifier body diode or external Schottky diode conduction and energy loss. Other current sensing techniques may also be used, including but not limited to, current sense resistors and current sensing transformers. Specific embodiments are disclosed.

### BRIEF DESCRIPTION OF THE DRAWINGS

FIG. 1 is a circuit diagram for the basic structure of a prior art current doubling, full wave output transformer coupled buck converter.

FIG. 2 illustrates the drain-source voltages of FET devices Q5 and Q6 of the prior art circuit of FIG. 1.

FIG. 3 shows the diode conduction current waveform in relation to the drain-source voltage waveform for the prior art circuit of FIG. 1.

FIG. 4 shows the absence of diode conduction current in a current doubling, full wave output transformer coupled buck converter incorporating the present invention.

FIG. 5 is a circuit diagram for a fully isolated current doubling full wave output converter incorporating an embodiment of the present invention.

FIG. 6 is a circuit diagram for a half wave output converter incorporating an embodiment of the present invention.

FIG. 7 is a circuit diagram similar to FIG. 6 showing an embodiment using a sense resistor RS.

FIG. 8 is a circuit diagram similar to FIG. 6 showing an embodiment using a current sense transformer CST.

FIG. 9 is a circuit diagram similar to FIG. 5 showing an embodiment using a sense resistor RS.

FIG. 10 is a circuit diagram similar to FIG. 5 showing an embodiment using a current sense transformer CST.

### DETAILED DESCRIPTION OF THE PREFERRED EMBODIMENT

First referring to FIG. 1, the basic structure for a prior art current doubling, full wave output transformer coupled buck converter may be seen. The present invention relates to the unwanted conduction of either the body diodes of FETs Q5 and Q6, or the Schottky diodes that might be connected with each FET (DQ5 and DQ6), respectively. The invention is particularly applicable to transformer coupled, switching power supplies operating with a continuous (forward) inductor current.

In the circuit of FIG. 1, transistors Q3 and Q2 are turned on during one half cycle while transistors Q4 and Q1 are off, with transistors Q4 and Q1 being turned on during the alternate half cycle while transistors Q2 and Q3 are off. Regulation is provided by a controller varying the duty cycle of transistors Q3 and Q2, and Q4 and Q1 during their active half cycle based on a feedback of the output voltage Vout, as is well known in the art. The synchronous rectifier switches Q5 and Q6 are switched generally in synchronism with the turn on of the respective primary side switch pair. With transistors Q3, Q2 and Q5 turned on and the other transistors turned off, the transformer T1 secondary voltage, which is higher than the output voltage Vout, preferably approximately twice the output voltage Vout, causes the respective output current component to increase through the leakage inductance Lleak and inductor L1.

When transistors Q3, Q2 and Q5 are turned off and transistors Q1, Q4 and Q6 are turned on, the transformer T1 secondary voltage reverses, and the current in inductor L1 starts to decrease. The current in the leakage inductance Lleak, which is at its peak of approximately Iout, cannot instantaneously reverse, but instead decays with a back EMF exceeding the secondary voltage to turn on the body or Schottky diode DQ5 associated with transistor Q5 until the current in the leakage inductance decays to zero. Thus during this period, instead of the leakage inductance and inductor L2 being coupled to the transformer secondary voltage to cause current to build in inductor L2, one end of inductor L2 is coupled to a voltage one diode forward conduction voltage drop below ground.

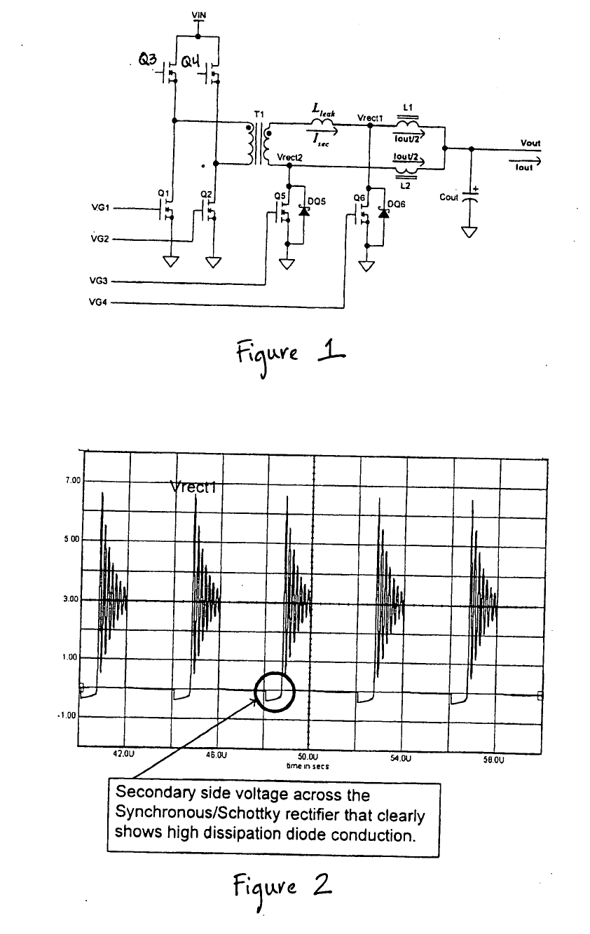

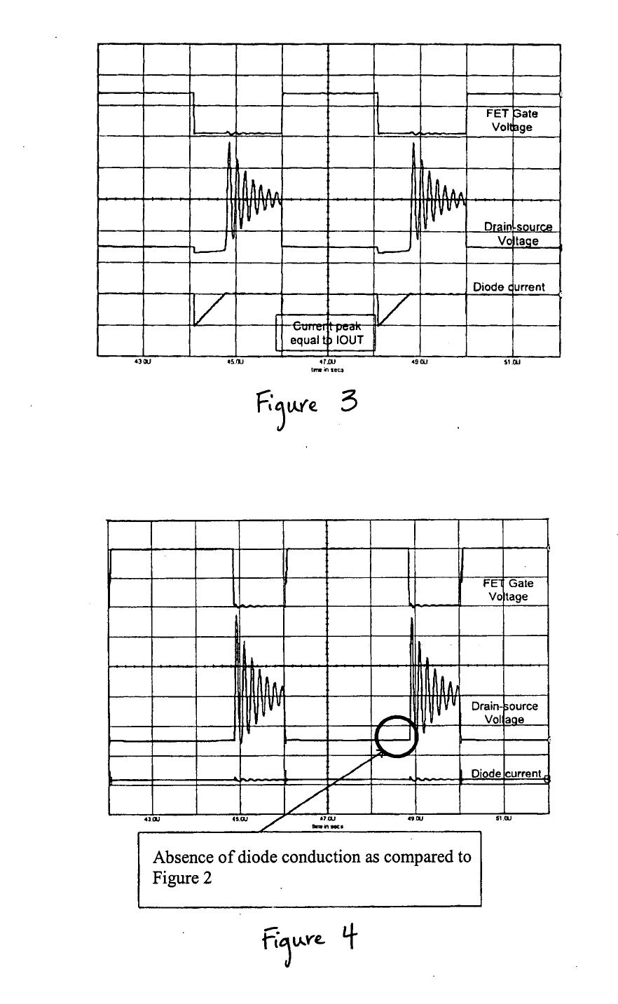

FIG. 2 shows the drain-source voltages of FET devices Q5 and Q6 with a non-adaptive gate drive waveform. This diagram assumes that the FET devices Q5 and Q6 are switched off, respectively, simultaneously with the associated switching of the primary side switching devices. This waveform results from the presence of the leakage inductance Lleak comprising the secondary referred uncoupled transformer and lead or PCB trace inductances. The current that conducts during this time is triangular with a starting or peak value approximately equal to the output current Iout. This conduction can result in losses that can be significant at low output voltages and high output currents.

FIG. 3 shows the diode conduction current waveform in relation to the drain-source voltage waveform. In conventionally designed synchronously rectified transformer coupled circuits with just primary side switching information, the secondary side gate voltage terminates prematurely. The diode currents are a function of both the amount of leakage inductance as well as the output current. The average current through each diode can be calculated by using the following formulas:

$${IDQ5}_{avg} = {IDQ6}_{avg} = \frac{1.2 {Iout}^{ 2} {NL}_{leak} {f}_{sw / leg}}{2 VIN}$$

Where:
IDQ5_{avg}=the average current through the diode associated with the FET Q5
IDQ6_{avg}=the average current through the diode associated with the FET Q5
Iout=the output current
N=number of turns on the secondary winding of the transformer
Lₗₑₐₖ=the sum of the secondary referred leakage and lead line inductances
F_{sw/leg}=the switching frequency for each leg
VIN=the input voltage

As an example, for a 50 A switching supply operating at 250 KHz from a 12 volt supply:

$$\begin{matrix}{IDQ5}_{avg} = {IDQ6}_{avg} \\ = \frac{1.2 {( 50 A )}^{2} ( 3 T ) ( 50 nH ) ( 250 KHz )}{2 ( 12 V )} \\ = 4.688 {A}_{avg}\end{matrix}$$

Clearly this would result in power dissipation across both diodes that is approximately given by the following formula:
PDQ5_{avg}=PDQ6_{avg}=IDQ5_{avg}VDQ5
PDQ5_{avg}=PDQ6_{avg}=(4.688 A) (0.45)=2.109 Watts

Assuming a 0.8V, 50 A power supply, this would represent up to 9% efficiency reduction. To mitigate this efficiency loss as a result of the parallel diode conduction, extra steps can be taken so that the gate drive across the respective synchronous rectifier is kept on until the current through the synchronous rectifier decays to zero, and then rapidly removed to avoid shorting the transformer. This can be accomplished by adapting the gate drive to the time when the current in the synchronous rectifier has decayed to zero, or alternately by monitoring the drain-source voltage of each FET, and removing the gate drive when the drain-source voltage goes to zero (approaches zero, goes through zero and/or starts to reverse).

The additional gate control circuit needed is minimal and for DC isolated (galvanic isolation) cases, can reside entirely on the secondary side of the transformer T1. Referring back to FIG. 3, the synchronous rectifier gate drive may be adaptively controlled, as an example, by using a gate control circuit to turn on the respective FET on command of the primary side controller. However, rather than turning off the FET on receipt of a turn-off signal from the controller, holding the respective FET on until the drain-source voltage of the FET begins to reverse, indicating that the current in the FET is beginning to reverse. When this is done, the resulting waveforms are shown in FIG. 4. As can clearly be seen from FIG. 4, the diode conduction has virtually been eliminated.

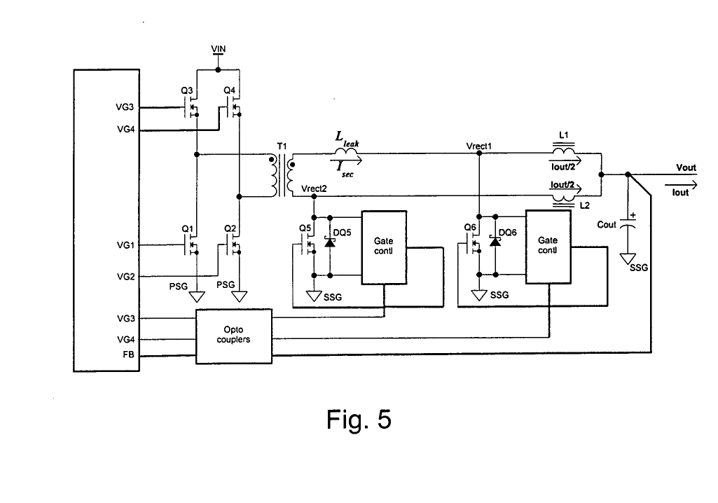

Now referring to FIG. 5, a circuit diagram for a fully isolated current doubling full wave output converter incorporating one embodiment of the present invention may be seen. For a fully isolated power supply, the gate drive signals from the controller may be coupled to the secondary side of the transformer T1 by any convenient isolation means, opto-couplers being shown, though other coupling means, such as transformer coupling could be used if desired (DC isolation (galvanic isolation) generally provides adequate isolation between the primary side and secondary side circuitry). Similarly, the output voltage may be fed back through some coupling means such as an opto-coupler for output voltage regulation purposes, which regulation control may be in accordance with the prior art. Accordingly, details of the regulation circuitry are not shown. With this isolation, the ground or neutral connections PSG on the primary side circuitry may be different from the secondary side ground or neutral SSG.

The gate drive signals VG5 and VG6 are used to cause the respective gate control circuits to each hold the respective FET on during the normal on-time of the respective FETs Q5 and Q6. When the respective gate drive signal VG5 or VG6 is removed (goes low in the embodiment shown), the respective gate control circuit will hold the respective FET on as long as the drain of the respective transistor remains at a voltage lower than the voltage on its source. When the respective drain voltage begins to rise above its source voltage (begins to reverse), the respective gate control circuit will rapidly turn off the device. In a way, the gate control circuit functions somewhat like an RS flip-flop, though is much more sensitive to the source-drain voltage (or other current sensing signal) around zero for the turn-off function.

Referring again to FIG. 5, when transistor Q5 is on, current will be flowing through the leakage inductance in the direction of the arrow I_{sec}, and through inductor L1 to the output. Current will also be flowing through inductor L2 to the output (based on the assumption of a continuous conduction converter). At the moment transistors Q1, Q4 and Q6 are turned on, the secondary voltage will reverse. However the current in the leakage inductance cannot instantaneously reverse, but instead, with transistor Q5 being held on by the gate control circuit, and neglecting voltage drops across transistors Q5 and Q6, the current in the leakage inductance Lleak will decay at a rate:
Vₛ=Lₗₑₐₖdiₗₑₐₖ/dt
Where:
Vₛ=the secondary voltage
iₗₑₐₖ=the current in the leakage inductance

With transistor Q5 still turned on, the source to drain current in transistor Q5 is equal to the leakage inductance current plus the current through inductance L2. The leakage inductance current needs to go through zero and increase in the reverse direction to equal the current through inductance L2 before the current in transistor Q5 starts to reverse, and the respective gate control circuit turns transistor Q5 off.

For purposes of illustration and not for purposes of limitation, the embodiment of the present invention herein before disclosed has been disclosed with respect to a full bridge primary side switching circuit. However the primary side switching circuit may be a half bridge or any other single ended topology as are well known in the art.

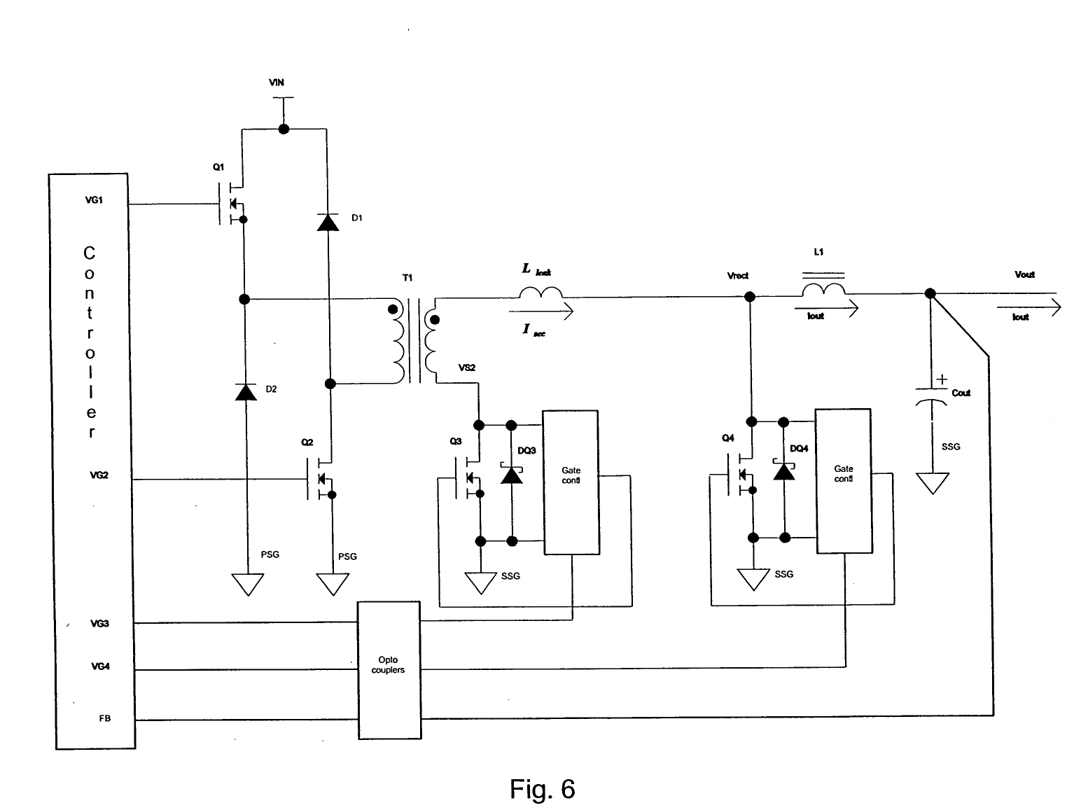

Now referring to FIG. 6, an embodiment of the present invention using a half wave secondary side output circuit may be seen. As before, the converter operates with a continuous current Iout in the inductor L1. In this embodiment, the primary side uses two switching transistors Q1 and Q2, and two diodes D1 and D2, with regulation being attained by control of the duty cycle of transistors Q1 and Q2. When transistors Q1 and Q2 are turned on, transistor Q3 is turned on (VG3 is driven high by the controller, causing the respective gate control circuit to drive the gate of transistor Q3 high, and VG4 is driven low. However, because of the current flow through transistor Q4 and the inductor L1 at the time of switching, the voltage across the transistor Q4 is negative. Thus the respective gate control circuit will leave transistor Q4 on even though the control signal VG4 has gone low. Also at the time of switching, the current in the leakage inductance Lleak will be zero, but will fairly rapidly increase. When the current in the leakage inductance Lleak begins to exceed the current in the inductor L1, the current through transistor Q4 will start to reverse, causing the respective gate control circuit to turn off transistor Q5. Thus transistor Q4 has been kept on until the current in the transistor goes to zero (or begins to reverse), preventing current flow and power loss through diode DQ4 during this time.

When transistors Q1 and Q2 are turned off, transistor Q4 is turned on (VG4 driven high) and VG3 is driven low. At the time of switching, the current in the leakage inductance Lleak is at a maximum. Consequently the voltage drop across transistor Q3 is negative, so the respective gate control circuit will keep transistor Q3 on until the current flow through and thus the voltage drop across transistor Q3 becomes positive, at which time the gate control circuit will turn off transistor Q3. Thus transistor Q3 has been kept on until the current in the transistor goes to zero (or begins to reverse), preventing current flow and power loss through diode DQ3 during this time.

In the embodiment of FIG. 6, the control signals VG3 and VG4 may be isolated such as by using opto-couplers, or may be directly connected to the controller, depending on whether a fully isolated power supply is desired or needed.

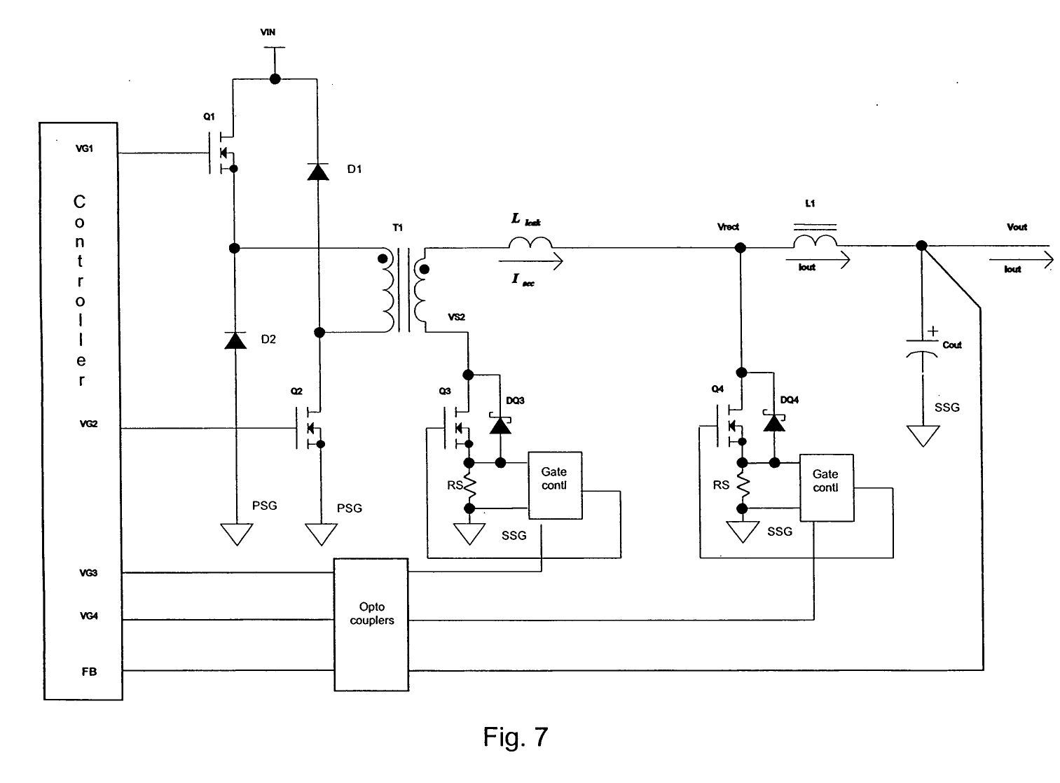

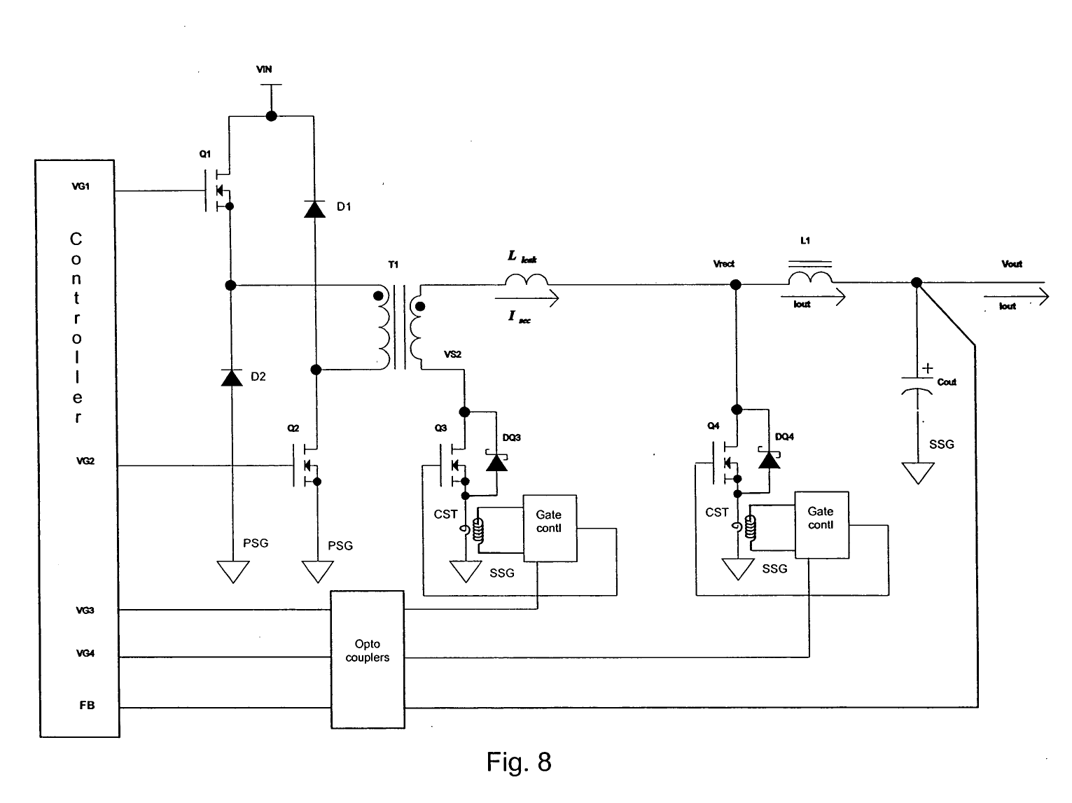

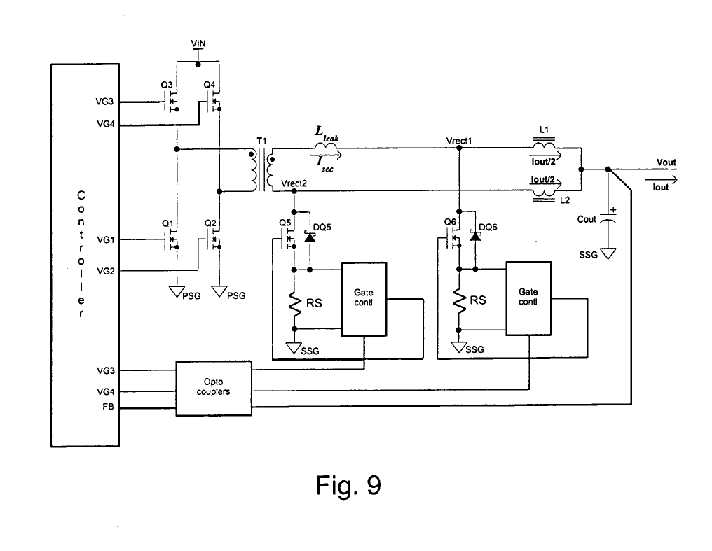

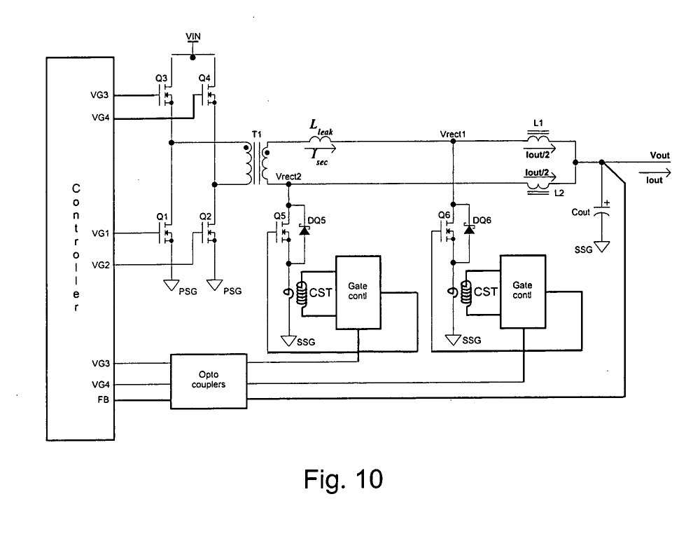

Now referring to FIG. 7, an embodiment using a sense resistor RS instead of the drain-source voltage may be seen. The circuit functions the same way, with the gate control circuit sensing the voltage drop across the resistor rather than the drain-source voltage on the transistor. Alternatively, the gate control circuit could sense the voltage across both the transistor and the resistor. FIG. 8 shows an embodiment using a current sense transformer CST. Either the current sense resistor or the current sense transformer could be on the other side of transistors Q3 and Q4, and of course could be used with other embodiments, such as the full wave embodiment of FIG. 5, as shown in FIGS. 9 and 10, respectively.

Also in any of the foregoing embodiments, or in other embodiments that may be obvious to those skilled in the art, the gate control circuit may be part of or integrated into the primary side controller if DC isolation is not required.

While certain preferred embodiments of the present invention have been disclosed and described herein, it will be understood by those skilled in the art that various changes in form and detail may be made therein without departing from the spirit and scope of the invention.

What is claimed is:

1. A method of operating a transformer coupled DC to DC converter having a pair of synchronous rectifiers coupled to a secondary winding of the transformer for providing a full wave power supply output comprising:
turning on one of the synchronous rectifiers in each half cycle of operation of the converter, and turning on the other synchronous rectifier in each alternate half cycle of operation of the converter;
sensing the direction of current flow through each synchronous rectifier when the other synchronous rectifier is turned on; and,
in response to the sensing, turning off each synchronous rectifier as the current there through goes to zero.

2. The method of claim 1 wherein the synchronous rectifiers are FETs, each having a source and a drain.

3. The method of claim 2 wherein sensing the direction of current flow through each synchronous rectifier comprises sensing the drain-source voltage of the respective FET.

4. The method of claim 2 wherein sensing the direction of current flow through each synchronous rectifier comprises sensing the voltage across a sense resistor in series with the respective FET.

5. The method of claim 2 wherein sensing the direction of current flow through each synchronous rectifier comprises sensing the output of a current sense transformer in series with the respective FET.

6. The method of claim 1 wherein turning on one of the synchronous rectifiers in each half cycle of operation of the converter, and turning on the other synchronous rectifier in each alternate half cycle of operation of the converter comprises, for each synchronous rectifier, setting a gate control circuit to a first state and using an output of the gate control circuit to turn on the respective synchronous rectifier, and changing the output of the gate control circuit to a second state as the current through the respective synchronous rectifier goes to zero and using the output of the gate control circuit to turn off the respective synchronous rectifier.

7. The method of claim 6 wherein the synchronous rectifiers are FETs, each having a source and a drain.

8. The method of claim 7 wherein sensing the direction of current flow through each synchronous rectifier comprises sensing the drain-source voltage of the respective FET.

9. A method of operating a transformer coupled DC to DC converter having a primary side switching circuit coupled to a primary winding of the transformer, a pair of synchronous rectifiers, each coupled to a respective end of a secondary winding of the transformer, a pair of inductors, each coupled between a respective synchronous rectifier and an output of the converter, and a controller controlling the primary side switching circuit, comprising, when operating with a continuous inductor current:
responsive to signals from the controller, turning on one of the synchronous rectifiers in each half cycle of operation of the converter, and turning on the other synchronous rectifier in each alternate half cycle of operation of the converter;
sensing the direction of current flow through each synchronous rectifier when the other synchronous rectifier is turned on; and,
in response to the sensing, turning off each synchronous rectifier as the current there through goes to zero.

10. The method of claim 9 wherein the synchronous rectifiers are FETs, each having a source and a drain.

11. The method of claim 10 wherein sensing the direction of current flow through each synchronous rectifier comprises sensing the drain-source voltage of the respective FET.

12. The method of claim 9 wherein turning on one of the synchronous rectifiers in each half cycle of operation of the converter, and turning on the other synchronous rectifier in each alternate half cycle of operation of the converter comprises, for each synchronous rectifier, setting a gate control circuit to a first state and using an output of the gate control circuit to turn on the respective synchronous rectifier, and changing the output of the gate control circuit to a second state as the current through the respective synchronous rectifier goes to zero and using the output of the gate control circuit to turn off the respective synchronous rectifier.

13. The method of claim 12 wherein the synchronous rectifiers are FETs, each having a source and a drain.

14. The method of claim 13 wherein sensing the direction of current flow through each synchronous rectifier comprises sensing the drain-source voltage of the respective FET.

15. The method of claim 10 wherein sensing the direction of current flow through each synchronous rectifier comprises sensing the voltage across a sense resistor in series with the respective FET.

16. The method of claim 10 wherein sensing the direction of current flow through each synchronous rectifier comprises sensing the output of a current sense transformer in series with the respective FET.

17. The method of claim 14 further comprised of electrically DC isolating the gate control circuits and the synchronous rectifiers from the controller.

18. The method of claim 9 further comprised of electrically DC isolating the synchronous rectifiers from the controller.

19. A transformer coupled power supply comprising:
a transformer having a primary winding and a secondary winding, each having first and second winding connections, the primary winding having an alternating voltage applied thereto under control of a controller;
first and second output switches; and,
first and second inductors;
the first inductor being coupled through the first output switch to the first secondary winding connection and to a power supply output;
the second inductor being coupled through the second output switch to a second secondary winding connection and to the power supply output;
the controller also being coupled to the first and second output switches for alternately turning on the first and second output switches synchronously with the alternating voltage applied to the primary winding;
a first gate control circuit responsive to the current through the first output switch to turn the first output switch off after the second output switch is turned on and the current through the first output switch decays to approximately zero; and,
a second gate control circuit responsive to the current through the second output switch to turn the second output switch off after the first output switch is turned on and the current through the second output switch decays to approximately zero.

20. The power supply of claim 19 wherein:
the first and second gate control circuits are coupled between the controller and the respective output switch, each gate control circuit being responsive to a respective output switch turn-on signal from the controller to put the respective gate control circuit in a first state turning on the respective output switch, each gate control circuit being responsive to the voltage across the respective output switch to put the gate control circuit in a second state to turn off the respective output switch.

21. The power supply of claim 20 further comprised of electrical DC isolation for the gate control circuits and the synchronous rectifiers from the controller.

22. The power supply of claim 19 wherein the output switches are FETs, each having a source and a drain.

23. The power supply of claim 22 wherein:
the first and second gate control circuits are responsive to the drain-source voltages of the respective FETs.

24. The power supply of claim 22 wherein:
the first and second gate control circuits are responsive to the voltage across a respective current sense resistor in series with the respective FET.

25. The power supply of claim 22 wherein:
the first and second gate control circuits are responsive to the output of a respective current sense transformer in series with the respective FET.

26. A method of operating a transformer coupled DC to DC converter having a switching circuit coupled to the primary of the transformer and a pair of synchronous rectifiers coupled to a secondary winding of the transformer for providing a power supply output comprising:
turning on each of the synchronous rectifiers in each cycle of operation of the converter at different times within the cycle coordinated with switching of the switching circuit;
sensing the direction of current flow through each synchronous rectifier while the respective synchronous rectifier is turned on; and,
turning off each synchronous rectifier as the current there through goes to zero.

27. The method of claim 26 wherein the synchronous rectifiers are FETs, each having a source and a drain.

28. The method of claim 27 wherein sensing the direction of current flow through each synchronous rectifier comprises sensing the drain-source voltage of the respective FET.

29. The method of claim 27 wherein sensing the direction of current flow through each synchronous rectifier comprises sensing the voltage across a sense resistor in series with the respective FET.

30. The method of claim 27 wherein sensing the direction of current flow through each synchronous rectifier comprises sensing the output of a current sense transformer in series with the respective FET.

31. The method of claim 26 wherein turning on the synchronous rectifiers comprises, for each synchronous rectifier, setting a gate control circuit to a first state and using an output of the gate control circuit to turn on the respective synchronous rectifier, and changing the output of the gate control circuit to a second state as the current through the respective synchronous rectifier goes to zero and using the output of the gate control circuit to turn off the respective synchronous rectifier.

32. The method of claim 31 wherein the synchronous rectifiers are FETs, each having a source and a drain.

33. The method of claim 32 wherein sensing the direction of current flow through each synchronous rectifier comprises sensing the drain-source voltage of the respective FET.

34. A method of operating a transformer coupled DC to DC converter having a primary side switching circuit coupled to a primary winding of the transformer, a pair of synchronous rectifiers, each coupled between a respective end of a secondary winding of the transformer and a ground connection, an inductor coupled between a respective synchronous rectifier and an output of the converter, and a controller controlling the primary side switching circuit, comprising, when operating with a continuous inductor current:
using the controller, turning on one of the synchronous rectifiers, and then turning on the other synchronous rectifier in each cycle of operation of the converter;
sensing the direction of current flow through each synchronous rectifier while the respective synchronous rectifier is turned on; and,
turning off each synchronous rectifier as the current there through goes to zero.

35. The method of claim 34 wherein the synchronous rectifiers are FETs, each having a source and a drain.

36. The method of claim 35 wherein sensing the direction of current flow through each synchronous rectifier comprises sensing the drain-source voltage of the respective FET.

37. The method of claim 35 wherein sensing the direction of current flow through each synchronous rectifier comprises sensing the voltage across a sense resistor in series with the respective FET.

38. The method of claim 35 wherein sensing the direction of current flow through each synchronous rectifier comprises sensing the output of a current sense transformer in series with the respective FET.

39. The method of claim 34 wherein turning on each synchronous rectifiers in each cycle of operation of the converter comprises, for each synchronous rectifier, a gate control circuit to a first state and using an output of the gate control circuit to turn on the respective synchronous rectifier, and changing the output of the gate control circuit to a second state as the current through the respective synchronous rectifier goes to zero and using the output of the gate control circuit to turn off the respective synchronous rectifier.

40. The method of claim 39 wherein the synchronous rectifiers are FETs, each having a source and a drain.

41. The method of claim 40 wherein sensing the direction of current flow through each synchronous rectifier comprises sensing the drain-source voltage of the respective FET.

42. The method of claim 41 further comprised of electrically DC isolating the flip-flop and the synchronous rectifiers from the controller.

43. The method of claim 34 further comprised of electrically DC isolating the synchronous rectifiers from the controller.

44. A transformer coupled power supply comprising:
a transformer having a primary winding and a secondary winding, each having first and second winding connections, the primary winding having an alternating voltage applied thereto under control of a controller;
first and second output switches; and,
an inductor;
each of the first and second output switches being coupled between a respective end of the secondary winding and a circuit ground;
the inductor being coupled between one end of the first secondary winding and a power supply output;
the controller also being coupled to the first and second output switches for alternately turning on the first and second output switches synchronously with switching of the voltage applied to the primary winding;
a first gate circuit responsive to the current through the first output switch to turn the first output switch off when the current through the first output switch is approximately zero; and,
a second gate control circuit responsive to the current through the second output switch to turn the second output switch off when the current through the second output switch is approximately zero.

45. The power supply of claim 44 wherein:
the first and second gate control circuits are coupled between the controller and the respective output switch, each gate control circuit being responsive to a respective output switch turn-on signal from the controller to put the respective gate control circuit in a first state turning on the respective output switch, each gate control circuit being responsive to the voltage across the respective output switch to put the gate control circuit in a second state to turn off the respective output switch.

46. The power supply of claim 45 further comprised of electrical DC isolation for the gate control circuits and the synchronous rectifiers from the controller.

47. The power supply of claim 44 wherein the output switches are FETs, each having a source and a drain.

48. The power supply of claim 47 wherein:
the first and second gate control circuits are responsive to the drain-source voltage of the respective FET.

49. The power supply of claim 47 wherein:
the first and second gate control circuits are responsive to the voltage across a respective current sense resistor in series with the respective FET.

50. The power supply of claim 47 wherein:
the first and second gate control circuits are responsive to the output of a respective current sense transformer in series with the respective FET.
